(19) United States
(12) Patent Application Publication
(10) Pub. No.: US 2025/0052290 A1
(43) Pub. Date: Feb. 13, 2025

(54) BRAKING SYSTEM WITH REDUCED TENDENCY TO SQUEAL IN COLD CONDITIONS, IN PARTICULAR FOR ELECTRIC VEHICLES, AND ASSOCIATED BRAKE PAD AND METHOD

(71) Applicant: ITT Italia S.R.L., Milan (IT)

(72) Inventors: Stefano BARALE, Barge (IT); Simone COGNO, Barge (IT); Andrea DELLA ROVERE, Barge (IT); Daniele DONZELLI, Barge (IT); Filippo GEDDA, Barge (IT); Aldo CANOVA, Barge (IT); Fabio FRESCHI, Barge (IT)

(73) Assignee: ITT Italia S.R.L., Milan (IT)

(21) Appl. No.: 18/722,679

(22) PCT Filed: Dec. 21, 2022
(86) PCT No.: PCT/IB2022/062584

§ 371 Date: Jun. 21, 2024

(30) Foreign Application Priority Data
Dec. 24, 2021 (IT) 102021000032645

(51) Int. Cl. F16D 65/00; B32B 15/04; B32B 15/18; F16D 65/092; F16D 127/00; F16D 129/06; H05B 6/10

(52) U.S. Cl. CPC F16D 65/0006; B32B 15/04; B32B 15/18; F16D 65/092; H05B 6/101; B32B 2307/56; B32B 2307/744; F16D 2127/00; F16D 2129/06

(57) ABSTRACT

Braking system (1) and method aimed to produce a forced increase in a damping layer (7) temperature of a brake pad (3), arranged between a metal support (5) and a friction material block (6) thereof, wherein the damping layer (7) is heated such as to stay at a temperature above a glass transition temperature of rubber components thereof, so assuring a maximum damping behavior; the heating is caused by magnetic induction generated by one or more electrically conducting coils (15) fed in AC by a power source (10) carried by the vehicle and arranged either integrated in the brake pad (3), e.g. carried by the support (5), or in the vicinity thereof.

### CROSS-REFERENCE TO RELATED APPLICATIONS

This Patent application claims priority from Italian Patent Application No. 102021000032645 filed on Dec. 24, 2021, the entire disclosure of which is incorporated herein by reference.

### TECHNICAL FIELD

The present invention relates to a braking system for vehicles and to an associated brake pad configured in order to reduce or even to eliminate the tendency of such brake pad to squeal during braking at relatively low temperatures. The braking system of the invention may include such a brake pad, a brake caliper and associated accessories, or a brake shoe with associated brake drum.

The present invention moreover relates to a complete brake element, in particular a brake pad, including all parts and accessories thereof (backplate, underlayer, friction material, shim, springs and all accessories necessary for its correct operation) configured to be used in such a braking system and to an associated method for reducing or even eliminating the tendency of a braking system to give raise to a squeal phenomenon during braking at relatively low temperatures.

### PRIOR ART

It is known that the brake pads under certain temperature and pressure conditions generate vibrations (1 Hz-16,000 Hz) which people perceived as squeals. This phenomenon, in general, occurs with greater reproducibility at low temperatures of the brake pad (here and below “low” temperature means a temperature lower than 50° C.); such low temperatures of the brake pad may occur immediately after starting a vehicle which has been parked for a long time, e.g. after the whole night, and/or when the environment temperature is close or below zero, like in winter.

In electric vehicles, due to regenerative braking system, the brake pads work at temperatures that are lower than the ones installed on a fuel-powered cars, so they are more subject to the squeal phenomenon. The absence of noise coming from a standard combustion engine, moreover, renders the cold brake squeal more perceptible.

In order to remove or to reduce cold noise, generally the pad manufacturer modify the formulation of the normally present underlayer (UL) to shift the glass transition point of the rubbers included in the UL. Below this temperature, the damping properties have a drastic drop. There are further countermeasures for this issue: modifying the friction material formulation, choosing different multilayer of materials for the anti-noise foil (shim) and optimizing the geometry of the pad in terms of chamfers and slot.

All the above solutions may however be complex to implement, costly and/or require optimization in order not to alter/reduce the braking performances of the brake pad or of the whole braking system.

### SUMMARY OF THE INVENTION

It is an object of the present invention to provide embodiments of a brake element, in particular a brake pad, and/or of an associated braking system of a vehicle aimed to reduce or even to avoid the noisiness produced in use by the squeal phenomenon.

It is in particular an object of the present invention to ensure a smooth and almost silent operation of a braking system, in particular forelectric or hybrid vehicles, especially in winter and anyway when the temperature of the brake elements, e.g. the brake pads, of the braking system are low, i.e. below 50° C.

It is moreover an object of the invention to provide an associated method for reducing or even eliminating the tendency of a braking system to give raise to squeal phenomena.

According to the present invention a braking system for vehicles and an associated braking element, preferably a brake pad, and further an associated method are therefore provided as defined in the appended claims.

In particular, the method of the invention is aimed to produce a forced increase in the underlayer (UL) temperature of the brake pad, which is independent of the natural increase of temperature that occur in operation due to the energy dispersed by friction during braking, so as to ensure that the underlayer always works at conditions that can assure the maximum damping behavior of the underlayer itself.

According to embodiments of the present invention, the underlayer is warmed up by providing, directly within the brake pad or in one of its components, a thermal power exploiting the principle of magnetic induction generated by an electromagnetic field.

The electromagnetic field may be generated by one or more electrically conducting coils that may be fed using electric power already present on the vehicle, e.g. produced by its engine or battery.

In a preferred embodiment, the electric coil/coils may be integrated in a brake pad structure, e.g. carried by the backplate, preferably in a shallow recess provided on the backplate rear face, facing on the side opposite to the element to be braked (e.g. a brake disc).

In different embodiments, the electric coil/coils may be carried out externally of the braking element, but close thereof, e.g. by the brake caliper.

### BRIEF DESCRIPTION OF DRAWINGS

Preferred but not limiting embodiments of the invention will be now described in more detail with reference to a number of practical working examples of implementation thereof which are solely intended to disclose in a non-exhaustive and not limiting manner the feature which are part of the content of the present disclosure, and with reference to the figures of the attached drawings, in which:

FIG. 1 shows a braking system according to the invention in its simplest configuration, including a braking element schematically shown in perspective view and designed to cooperate with an element to be braked, e.g. a brake disk;

FIG. 2 shows schematically in an enlarged scale the braking element of FIG. 1 in a partially exploded;

FIGS. 3 and 4 are respective graphics showing the behavior in operation of the braking system of the invention;

FIG. 5 shows schematically in a further enlarged scale a perspective view of the braking element of FIG. 1 with parts partially removed to illustrate the internal structure thereof;

FIG. 6 shows schematically a different embodiment of the braking system according to the invention; and

FIG. 7 shows schematically two possible configurations of electric coils which are part of some embodiments of the braking system of the invention.

### DETAILED DESCRIPTION

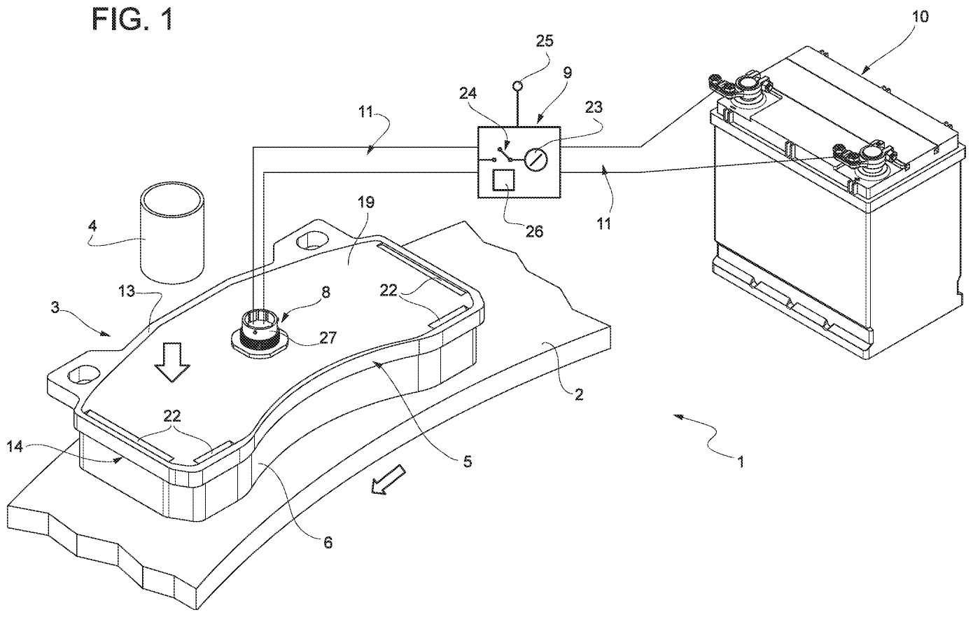

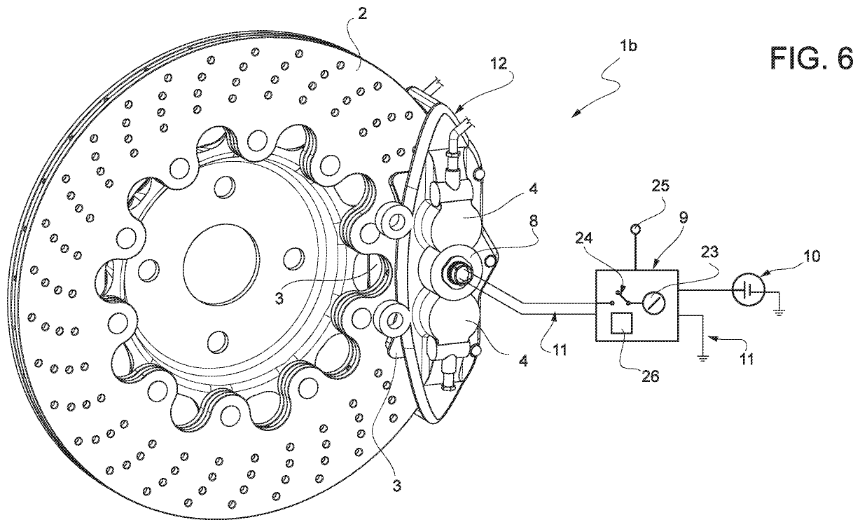

With reference to FIGS. 1 and 6, the reference number 1 (and 1b in FIG. 6) indicates a braking system for a vehicle (known and not illustrated for sake of simplicity) comprising: an element to be braked 2, e.g. a brake disk or brake drum, configured to be in use angularly connected to a vehicle wheel hub (known and not illustrated for sake of simplicity); and at least a braking element 3, e.g. a brake pad or a brake shoe, configured to cooperate in use by friction with the element to be braked 2 under the action of at least an actuator 4 (only schematically shown in FIG. 1 and e.g. consisting in a brake piston which is part of a braking circuit of the vehicle) configured to push, when activated, the braking element 3 against the element to be braked in the direction of the arrow (FIG. 1).

Here, and herein below, reference will be made to a brake pad 3 and to a brake disk 2 without losing in generality.

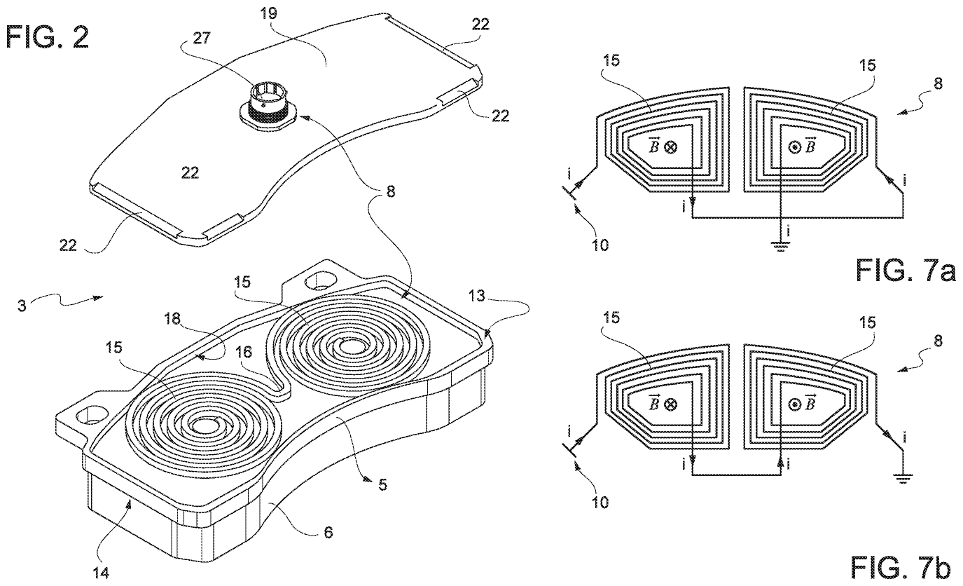

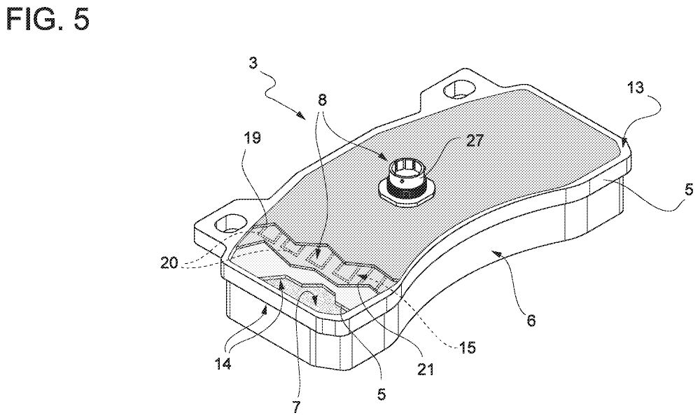

With reference also to FIGS. 2 and 5, the braking element 3 comprises a metal support 5, in the case in point a backplate 5 of the brake pad 3, a block of friction material 6 carried by the support 5 and a damping layer 7 (visible only in FIG. 5, where the brake pad 3 is shown partially sectioned) in the case in point an underlayer or UL 7 of the brake pad 3. The damping layer/underlayer 7 is carried by the metal support 5 interposed between the support 5 itself and the friction material block 6, according to a known layout.

According to an aspect of the invention, the braking systems 1 and 1b further comprise an electric device 8 shown only schematically in FIGS. 1 and 6, configured, as it will be seen, to warm up/heat the damping layer 7, a control unit 9 (shown only schematically as a block), configured to switch on and off the electric device 8, and a power source 10 for the electric device 8 and the control unit 9.

In the non-limitative embodiments shown the power source 10 operates in DC and consists of a vehicle battery connected to the control unit 9 and to the electric device 8 by means of an electric circuit 11 provided on-board the vehicle.

It is clear anyway that, according to possible embodiments not shown for sake of simplicity, the power source 10 could be provided directly on-board the brake pad 3 or on-board a brake caliper 12 (FIG. 6) carrying in known manner a pair of brake pads 3 arranged facing to each other and facing on opposite sides a brake disk 2 arranged therebetween and with the brake caliper 12 arranged astride the brake disk 2.

It is also clear that the control unit 9 may be carried on-board the vehicle or directly on-board each brake pad 3 or on-board the brake caliper 12.

Moreover, the power supply to the electric device 8 may be fed wireless from the power source 10, instead of using an electric circuit like electric circuit 11.

According to a further aspect of the invention, the electric device 8 consists of at least an electromagnetic inductor configured to generate a magnetic field when powered by the power source 10 in response to the control unit 9.

The at least one electromagnetic inductor 8 is to be arranged sufficiently close to the braking element 3 to concatenate the magnetic field generated by inductor 8 with the metal support 5, normally made in a ferromagnetic material, like iron or steel and/or any electro-conductive/ferromagnetic component of the braking element. As non-limitative examples, the at least one inductor 8 may generate a magnetic field which concatenates not only or not even (e.g. if made of a light alloy) the support 5, but ferromagnetic powders contained in the friction material block 6 or in other well-known components of the brake pad 3, like the shim and/or the metallic springs of the brake pad 3 e.g. cooperating with the brake caliper 12.

In a first and preferred embodiment of the invention (FIGS. 2 and 5) the at least one electromagnetic inductor 8 is carried by the support 5 on a first face 13 thereof, which is opposite to a second face 14 of the support 5 carrying the damping layer 7 and the friction material block 6 arranged above/onto the damping layer 7.

The electromagnetic inductor 8 comprises a pair of electric conductive and insulated coils 15 (FIGS. 2, 5 and 7) which are electrically connected in series to each other and to the power source 10.

The electric connection between the pair of conductive coils 15 may be selected in the group consisting in: full series as shown in FIG. 7a, in order to establish two adjacent magnetic fluxes which are concordant; and anti-series as shown in FIG. 7b, in order to establish two adjacent magnetic fluxes which are discordant.

In a first embodiment (FIG. 2), the pair of electric coils 15 may be formed by an insulated electric wire 16 housed in a shallow recess 18 of the first face 13 of the support 5, which shallow recess 18 is closed by a cover 19, in order to protect and further insulate the electric wire 16.

In a second embodiment (FIG. 5) the pair of electric coils 15 may be formed by electrically insulated metal tracks 20 screen printed or electro-deposited on the first face 13 of the support 5, e.g. embedded in/covered by an electrical insulating layer 21. Preferably, the tracks 20 and the insulating layer 21 are protected by a cover 19. In both the embodiments of FIGS. 2 and 5 the cover 19 may be welded to the support 5 or connected thereto in permanent or removable manner by any suitable method, e.g. by means of deformable flaps 22.

With reference to the embodiment shown in FIG. 6, the braking element is to be a brake pad 3 and the at least one electromagnetic inductor 8 is carried by the brake caliper 12, which is an integral part/element of the braking system 1b itself; the brake caliper 12 carries a pair of brake pads 3 facing each other and facing from opposite sides the brake disk 2 arranged therebetween.

The brake caliper 12 carries on each side of the brake disk 2 at least one electromagnetic inductor 8 and, on at least one side of the brake caliper, at least one (a pair in the example shown) of the actuators 4 for each respective brake pad 3. In this manner, also in this embodiment the electromagnetic inductors 8 are arranged sufficiently close to the brake pads 3 to concatenate in their magnetic field the metal supports 5 of the brake pads 3.

The braking system 1 or 1b may include one control unit 9 for each pairs of brake pads carried by the same brake caliper 12 or one single control unit 9 controlling all the electromagnets 8 paired to all the elements 2 to be braked: in the first case each brake caliper 12 carries on-board a control unit 9 for its braking elements 3. In the second case, the single control unit 9 may be carried on-board the vehicle.

In any case, each single control unit 9 comprises, as only schematically shown in FIGS. 1 and 6, a timer 23, an electronic switch 24 configured to selectively feed power to the at least one electromagnetic inductor 8 by selectively connecting it to the power source 10 after that the timer 23 has run for an established period of time, and a temperature sensor 25, or a connection to a temperature sensor of the vehicle, configured to detect the environment temperature.

The control unit 9 is configured to switch on the electromagnetic inductor 8 when the environment temperature is below a prefixed threshold and to switch off the electromagnetic inductor 8 after that the aforementioned established period of time has expired.

The control unit 9 may be preferably, but not exclusively, configured to set the established period of time in function of the environment temperature measured by sensor 25, e.g. in case of very cold weather the established period of time may be set by the control unit 9 longer than in case of higher environment temperature.

The power source 10 may be preferably a DC power source, preferably a vehicle battery, and in such a case the control unit 9 further includes a MOSFET LC oscillator 26 (known as Royer oscillator), known per se, to convert DC electric current delivered by the power source 10 into AC electric current to be fed to the electromagnetic inductor 8.

According to an aspect of the invention, the electromagnetic inductor 8 is configured to operate with a pre-set frequency, comprised between approximately 20 kHz and 85 KHz, and is further configured to generate a magnetic induction field to induce within the metal support 5 and/or in any conductive part of the braking element 3 an induced electric current such as to generate therein in a power comprised approximately between 70 and 90 watt in order to heat such component/s at the desired temperature.

The timer 23 may be configured to set the aforementioned established period of time set lower than, or approximately equal to, 60 seconds.

It is evident from what described above that the present invention also extends to a brake pad 3 for equipping a braking system 1 or 1b of a vehicle, comprising a metal support 5, a block of friction material 6 carried by the support 5 and a damping layer 7 or underlayer, carried by the support 5 interposed between the support 5 and the friction material block 6.

The brake pad 3 according to the invention also comprises, in combination: at least one electromagnetic inductor 8 carried by the support 5 on a first face 13 thereof, which is opposite to the second face 14 carrying the damping layer 7 and the friction block 6 arranged above the damping layer 7; either one power source 10 in AC or DC or an element (e.g. a connector) 27 (only schematically shown in FIGS. 1, 2 and 5 in a generic, non-limitative position for pictorial purposes only) configured to feed to the inductor 8 the current generated by an AC or DC power source 10 of the vehicle; in the case of a DC power source, a DC/AC converter 26 carried onboard the support 5; and a control unit 9 to switch off the power to the at least one electromagnetic inductor 8 after the expiration of a pre-set period of time.

Preferably, the support 5 carries a pair of conductive coils 15 arranged side by side in order to cover the majority of the surface extension of the first face 13 of the support 5 and electrically connected to each other either in full series, such as to establish onto the support two adjacent magnetic flux which are concordant, or in anti-series, such as to establish onto the support two adjacent magnetic flux which are discordant.

It is finally evident that the present invention also relates to a method for eliminating or at least reducing the tendency of a braking element 3, in particular a brake pad, to squeal during cold braking maneuvers of a vehicle equipped with such braking element 3, wherein the braking element 3 comprises a metal support 5, a friction block 6 carried by the metal support 5 and a damping layer 7 or “underlayer”, interposed between the support 5 and the friction block 6.

The method of the invention comprises the step of selectively producing a forced increase in a temperature of the damping layer 7, which increase is independent of a natural temperature increase of the damping layer 7 that occurs in use due to the energy dispersed by friction during the braking maneuver.

The increase in temperature is set such as to maintain the whole damping layer 7 constantly above a glass transition temperature of rubber components thereof, as shown in the graph of FIG. 4, so as to ensure that the damping layer 7 always works at conditions assuring maximum damping behavior of the same; in other words, the induced temperature increase is such as to keep the underlayer 7 in a temperature interval corresponding to the “rubber plateau” shown in FIG. 4.

According to a preferred embodiment of the invention, the damping layer or underlayer 7 is heated by providing, directly within conductive and/or ferromagnetic parts of the braking element 3 a magnetic induction heating generated by an electromagnetic field concatenated with either the whole braking elements 3 or with ferromagnetic parts thereof, e.g. the metal support or backplate 5.

The electromagnetic field is generated by at least one electromagnetic inductor 8 arranged onto/carried by the support 5, or arranged in its vicinity, like as onto the brake caliper 12.

The electromagnetic field is generated by powering in AC a pair of electric insulated electrically conducting coils 15 arranged to constitute an electromagnetic inductor 8 and fed with an AC electric current generated by an electric power source 10 present on the vehicle, e.g. by means of a DC power source connected in series with a DC/AC converter, preferably a MOSFET oscillator.

The electromagnetic field is generate by operating the electromagnetic inductor 8 with a pre-set frequency, comprised between approximately 20 kHz and 85 KHz and so as to generate a magnetic induction field to induce within the metal support 5 and/or in any other conductive part of the braking element 3 an induced electric current such as to generate therein a power comprised approximately between 70 and 90 watt, with e.g. a volumic power density of about 0.18 watt/mm³.

The magnetic induction heating of the underlayer 7 is carried out for an established period of time set by a timer 23 and lower than, or approximately equal to, 60 seconds, starting from the switching of the electromagnetic inductor 8.

Still according to the method of the invention, the electromagnetic induction heating is triggered when the environment temperature sensed by a temperature sensor 25, goes below a prefixed value and/or the vehicle performs a cold start, e.g. after a whole night parking.

Experimental tests have been carried out by using a commercial brake pad equipped handcrafted with an electromagnetic inductor 8 obtained by coiling an electric wire 16 to obtain two coils 15 covering the majority of the surface extension of face 13 (herein for “majority” of a surface it is intended more than 60% of the surface).

Two identical brake pads are tested, but carrying friction blocks 6 made of different friction material mixtures; the coils 15 on the two brake pads are fed with a same power of 80 watt and the temperature of the underlayer is monitored in different points by means of a temperature sensor.

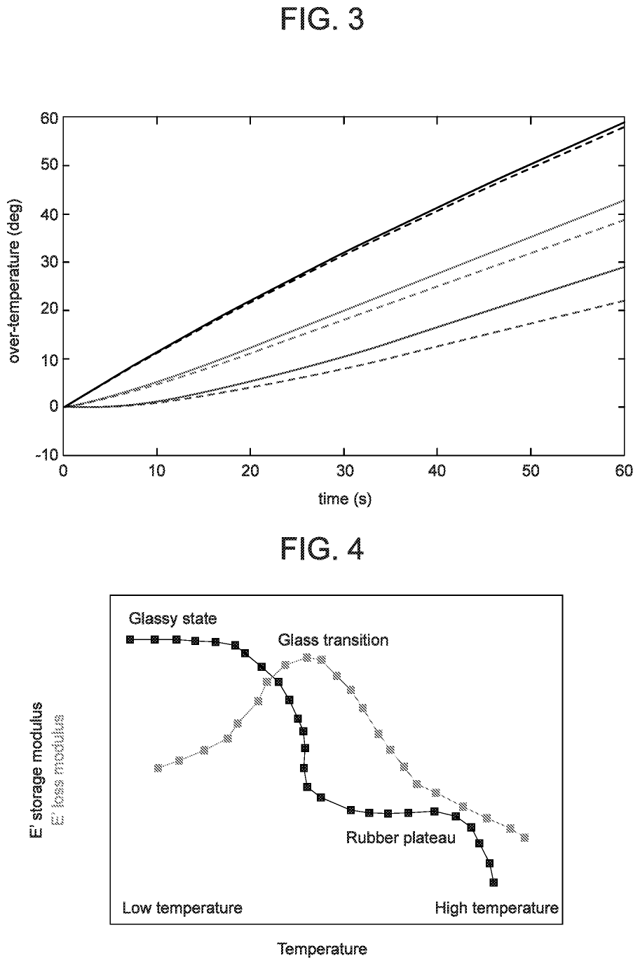

The results are given in the graphics of FIG. 3, wherein the curve over-temperature (with respect to the environment) upon time is reported for the minimum local temperature detected, the maximum local temperature detected and the average temperature detected and for both the different friction mixtures (for one mixture in continuous line, for the other friction mixture in dotted line).

As it can be seen in FIG. 3, after about 60 seconds, the desired over-temperatures of 40° C. are reached on average in both brake pads with different friction mixtures, although not homogeneously along the thickness of the underlayer 7

All the aims of the present disclosure are therefore fulfilled.

### Certain Terminology

Although certain braking devices, systems, and methods have been disclosed in the context of certain example embodiments, it will be understood by those skilled in the art that the scope of this disclosure extends beyond the specifically disclosed embodiments to other alternative embodiments and/or uses of the embodiments and certain modifications and equivalents thereof, like brake shows for braking systems based on brake drums. Use with any structure is expressly within the scope of this invention. Various features and aspects of the disclosed embodiments can be combined with or substituted for one another in order to form varying modes of the assembly. The scope of this disclosure should not be limited by the particular disclosed embodiments described herein.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Unless stated otherwise, the terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Likewise, the term “generally” as used herein represents a value, amount, or characteristic that predominantly includes or tends toward a particular value, amount, or characteristic.

This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

1. A vehicle braking system (1;1b) for vehicles comprising:
an element to be braked (2) configured to be in use angularly connected to a wheel hub of a vehicle; and
at least a braking element (3) configured to cooperate in use by friction with the element to be braked under the action of an actuator (4), the braking element comprising:
a metal support (5);
a block (6) of friction material carried by the support; and
a damping layer (7) carried by the support (5) interposed between the support and the friction material block (6);
an electric device (8) configured to warm up the damping layer (7);
a control unit (9) to switch on and off the electric device; and
a power source (10) for the electric device and the control unit.

2. The braking system of claim 1, wherein the electric device comprises: at least an electromagnetic inductor (8) configured to generate a magnetic field when powered by the power source (10) in response to the control unit (9), the at least one electromagnetic inductor (9) being arranged sufficiently close to the braking element (3) to concatenate in its magnetic field the metal support (5) and/or any electro-conductive component of the braking element (3).

3. The braking system of claim 1, wherein the at least one electromagnetic inductor (8) is carried by the support (5) on a first face (13) thereof, which is opposite to a second face (14) of the support carrying the friction block (6).

4. The braking system of claim 3, wherein
the electromagnetic inductor (8) comprises a pair of electric conductive and insulated coils (15) which are electrically connected in series to each other and to the power source (10);
the electric connection between the pair of conductive coils (15) is selected from full series, in order to establish two adjacent magnetic fluxes which are concordant; and anti-series, in order to establish two adjacent magnetic fluxes which are discordant.

5. The braking system of claim 4, wherein the pair of electric coils (15) are formed: either by an insulated electric wire (16) housed in a shallow recess (18) of the first face (13) of the support, which shallow recess is closed by a cover (19); or by electrically insulated metal tracks (20) screen printed on the first face (13) of the support.

6. The braking system of claim 1, wherein
the at least one braking element comprises a brake pad (3); and
the at least one electromagnetic inductor (8) is carried by a brake caliper (12) forming part of the braking system (1b) itself and carrying a pair of brake pads (3) facing each other and facing from opposite sides to a brake disk (2) arranged therebetween, the brake caliper (12) carrying on each side of the brake disk at least one electromagnetic inductor (8) and at least on one side thereof at least one said actuator (4) for a respective brake pad.

7. The braking system of claim 2, wherein
the control unit (9) includes:
a timer (23);
an electronic switch (24) configured to selectively feed power to the at least one electromagnetic inductor (8) by selectively connecting it to the power source (10) after that the timer has run for an established period of time; and
a temperature sensor (25) or a connection to a temperature sensor (25) of the vehicle, configured to detect the environment temperature; and
the control unit (9) is configured to:
switch on the electromagnetic inductor (8) when the environment temperature is below a prefixed threshold and to switch off the electromagnetic inductor after the established period of time has expired; and
set the said established period of time as a function of the environment temperature.

8. The braking system of claim 7, wherein
the power source (10) is a DC power source;
the control unit further includes a MOSFET LC oscillator (Royer oscillator) (26) to convert DC electric current delivered by the power source (10) into AC electric current to be fed to the electromagnetic inductor (8);
the electromagnetic inductor (8) is configured to operate with a pre-set frequency, comprised between approximately 20 kHz and 85 KHz, and is further configured to generate a magnetic induction field to induce within the metal support (5) and/or in any conductive part of the braking element (3) an induced electric current such as to generate therein a power comprised approximately between 70 Watts and 90 Watts in order to heat the braking element to a desired temperature; and
the established period of time set in the timer being lower than, or approximately equal to, 60 seconds.

9. A brake pad (3) for equipping a braking system (1;1b) of a vehicle, the brake pad comprising:
a metal support (5);
a block of friction material (6) carried by the support; and
a damping layer (7) or “underlayer”, carried by the support (5) interposed between the support and the friction material block;
at least one electromagnetic inductor (8) carried by the support (5) on a first face (13) thereof, which is opposite to a second face (14) of the support carrying the friction block (6);
an AC power source, a DC power source, or an element (27) to feed the inductor (8) from an AC or DC power source (10) of the vehicle, wherein the brake pad, in the case of the DC power source, further comprises a DC/AC converter (26) carried onboard the support (5); and
a control unit (9) to switch off power to the at least one electromagnetic inductor (8) after the expiration of a pre-set period of time.

10. The brake pad of claim 9, wherein the support (5) carries a pair of conductive coils (15) arranged side by side in order to cover the majority of the surface extension of said first face (13) of the support and electrically connected to each other either in full series, such as to establish onto the support two adjacent magnetic flux which are concordant, or in anti-series, such as to establish onto the support two adjacent magnetic flux which are discordant.

11. A method for eliminating or at least reducing a tendency of a braking element (3), in particular a brake pad, to squeal during cold braking maneuvers of a vehicle equipped with the braking element, the braking element comprising a metal support (5), a friction block (6) carried by the metal support and a damping layer (7) or “underlayer”, interposed between the support and the friction block, the method comprising:
selectively producing a forced increase in a temperature of the damping layer (7), which increase is independent of a natural temperature increase of the damping layer (7) that occurs in use due to the energy dispersed by friction during the braking maneuver; the increase in temperature being set such as to maintain the whole damping layer (7) constantly above a glass transition temperature of rubber components thereof, so as to ensure that the damping layer (7) always works at conditions assuring maximum damping behavior of the same.

12. The method of claim 11, wherein producing the forced increase in the temperature of the damping layer (7) comprises providing, directly within conductive and/or ferromagnetic parts of the braking element (3), a magnetic induction heating generated by an electromagnetic field concatenated with either the whole braking elements or with ferromagnetic parts thereof, wherein
the electromagnetic field is generated by at least one electromagnetic inductor (8) arranged onto/carried by the support, or arranged in its vicinity; and
the electromagnetic inductor comprises a pair of electric insulated electrically conducting coils (15) fed with an AC electric current generated by an electric power source (10) present on the vehicle.

13. The method of claim 12, wherein
the electromagnetic inductor (8) is operated with a pre-set frequency, comprised between approximately 20 kHz and 85 KHz; and
the magnetic induction heating is carried out by generating a magnetic induction field to induce within the metal support (5) and/or in any conductive part of the braking element (3) an induced electric current such as to generate therein a power comprised approximately between 70 Watts and 90 Watts in order to heat the braking element to a desired temperature.

14. The method of claim 12, wherein the magnetic induction heating is carried out for an established period of time set by a timer and lower than, or approximately equal to, 60 seconds, starting from the switching on of the electromagnetic inductor (8).

15. The method of anyone of claim 12, wherein the magnetic induction heating is triggered when the environment temperature sensed by a temperature sensor (25), goes below a prefixed value and/or the vehicle performs a cold start.
